(19) United States
(12) Patent Application Publication
(10) Pub. No.: US 2009/0268431 A1
(43) Pub. Date: Oct. 29, 2009

(54) ILLUMINATION DEVICE FOR DISPLAY DEVICE AND DISPLAY DEVICE PROVIDED THEREWITH

(75) Inventor: Yoshiki Takata, Suzuka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/295,384

(22) PCT Filed: Feb. 14, 2007
(86) PCT No.: PCT/JP2007/052613

§ 371 Date: Sep. 30, 2008

(30) Foreign Application Priority Data
Jul. 3, 2006 (JP) 2006-183761

(51) Int. Cl. G02F 1/13357

(52) U.S. Cl. 362/97.1

(57) ABSTRACT

An illumination device for use in a display device or display-device illumination device, includes a plurality of tubular lamps that can be driven in parallel, a first holding member having the same number of holders as the number of the tubular lamps, the holders of the first holding member being arranged to hold first ends of the tubular lamps, a second holding member having the same number of holders as the number of the tubular lamps, the holders of the second holding member being arranged to hold second ends of the tubular lamps, a power supply arranged to supply electric power to the tubular lamps through the first holding member and the second holding member, and a chassis for use in a display-device illumination device. The first holding member and the second holding member are fixed to the chassis for use in a display-device illumination device so as to have freedom of movement in the direction of the main axes of the tubular lamps. This helps reduce the possibility of lamps being broken due to thermal stress.

### BACKGROUND OF THE INVENTION

1. Field of the Invention

The present invention relates to an illumination device for use in a display device (hereinafter, “display-device illumination device”) and a display device incorporating such a display-device illumination device. More particularly, the present invention relates to a display-device illumination device having a plurality of lamps that can be driven in parallel and a display device incorporating such a display-device illumination device.

2. Description of the Related Art

Since typical cold cathode lamps for use as light sources in display devices have a non-linear negative impedance characteristic, parallel driving cannot be achieved and thus a power supply circuit is generally provided for each of the cold cathode lamps. Disadvantageously, however, this requires as many power supply circuits as there are cold cathode lamps, thus resulting in increased cost. This also produces disadvantages in terms of compactness, lightness and cost reduction.

Typical cold cathode lamps for use as light sources in display devices are connected to power supply circuits via harnesses (also called lead wires) and connectors. Thus, it is time-consuming to mount the cold cathode lamps, and this results in poor efficiency with which a display-device illumination device incorporating the cold cathode lamps is assembled. It is also time-consuming to dismount the cold cathode lamps, and this results in poor efficiency with which the cold cathode lamps are replaced and poor efficiency with which a display-device illumination device incorporating the cold cathode lamps is disassembled when disposed of.

As lamps that can overcome such disadvantages, external electrode fluorescent lamps (EEFLs) (for example, see JP-A-2004-031338 and JP-A-2004-039264) and cold cathode lamps (for example, see WO2006/051698 A1) for which the present applicant has already applied for a patent are disclosed. These lamps can be driven in parallel, and the ends of the lamps are held, by holders formed by elastic metal members (made of, for example, spring steel), through the elastic action of the holders. This allows power to be supplied to the lamps through the holders. Advantageously, this configuration allows easy mounting and dismounting of the lamps.

In the above-described display-device illumination device incorporating a plurality of lamps that can be driven in parallel, as shown in FIG. 17, one end of each lamp 200 is held by a holder 201A disposed in a first holding member 201, and the other end of each lamp 200 is held by a holder 202A disposed in a second holding member 202. An alternating-current voltage having a frequency of several tens of kilohertz is supplied from a power supply 203 to each lamp 200 through the first holding member 201 and the second holding member 202. The holders 201A and 202A formed by elastic metal members (made of, for example, spring steel) are provided such that they are each equal in number to the lamps. The cross sectional view of the second holding member 202 shown in FIG. 17 taken along line A-A′ is shown in FIG. 18A; the cross sectional view of the second holding member 202 shown in FIG. 17 taken along line B-B′ is shown in FIG. 18B. The first holding member 201 has the same shape as the second holding member 202.

As shown in FIG. 19, the first holding member 201 is fixed to a first insulating member 204 without freedom of movement; the first insulating member 204 is fixed, without freedom of movement, to a chassis 206 in the display-device illumination device. Likewise, the second holding member 202 is fixed to a second insulating member 205 without freedom of movement; the second insulating member 205 is fixed, without freedom of movement, to the chassis 206 in the display-device illumination device.

In a case where the chassis 206 in the display-device illumination device is formed of aluminum or stainless steel, it is necessary to keep the chassis 206 in the display-device illumination device out of contact with the first holding member 201 and the second holding member 202. In a case where the chassis 206 in the display-device illumination device is formed of insulating member such as resin, the chassis 206 in the display-device illumination device may be in contact with the first holding member 201 and the second holding member 202. Thus, the first insulating member 204 and the second insulating member 205 may be removed, and they may be directly fixed to the chassis 206 in the display-device illumination device.

Here, consider the display-device illumination device when its operation is started. Prior to the start of the operation, the lamps and the chassis in the display-device illumination device are at room temperature (for example, 25° C.). After the operation is started and thus the lamps are lit, the temperature of the lamps rapidly increases to about 80° C. (for example, in several minutes). In contrast, the temperature of the chassis in the display-device illumination device slowly increases from room temperature to about 50° C. (for example, over a period of an hour or more).

Now, consider the display-device illumination device when its operation is completed. When the operation is completed and thus the lamps are turned off, the temperature of the lamps rapidly decreases from about 80° C. to about 50° C. (for example, in several minutes) and subsequently decreases to room temperature slowly (for example, over a period of an hour or more). In contrast, the temperature of the chassis in the display-device illumination device slowly decreases from about 50° C. to room temperature (for example, over a period of an hour or more).

This phenomenon occurs because of the following reasons: the lamps are heat sources and have a low heat capacity, and thus they have rapid variations in temperature; in contrast, the chassis in the display-device illumination device is not a heat source but a component that receives heat from the lamps and has a high heat capacity, and thus it has slow variations in temperature as compared with the lamps.

In a case where the first holding member 201 and the second holding member 202 are fixed, without freedom of movement, to the chassis 206 in the display-device illumination device as described above, when the above-described phenomenon occurs, the lamps are subjected to high thermal stress. This may cause the lamps to be broken. Since the lamps are driven in parallel, thermal stress exerted on the lamps is especially high.

### SUMMARY OF THE INVENTION

Preferred embodiments of the present invention provide a display-device illumination device that can reduce the possibility of lamps being broken due to thermal stress and a display device incorporating such a display-device illumination device.

According to a preferred embodiment of the present invention, a display-device illumination device includes: a plurality of tubular lamps that can be driven in parallel; a first holding member having the same number of holders as the number of the tubular lamps, the holders holding first ends of the tubular lamps; a second holding member having the same number of holders as the number of the tubular lamps, the holders holding second ends of the tubular lamps; a power supply arranged to supply electric power to the tubular lamps through the first holding member and the second holding member; and a chassis for use in a display-device illumination device. Here, the first holding member and the second holding member are fixed to the chassis for use in a display-device illumination device so as to have freedom of movement in the direction of main axes of the tubular lamps. If electric power can be supplied to the tubular lamps through the first holding member and the second holding member such as by capacitive coupling, an insulating coating may be applied to the holders.

With this configuration, the first holding member and the second holding member are fixed to the chassis for use in a display-device illumination device so as to have freedom of movement in the direction of the main axes of the tubular lamps. Thus, as the tubular lamps thermally expand or contract, the first holding member and the second holding member can move together with the tubular lamps. Hence, it is possible to significantly reduce thermal stress exerted on the tubular lamps in the direction of the main axes of the tubular lamps. This helps reduce the possibility of the tubular lamps being broken due to thermal stress.

In a case where the chassis for use in a display-device illumination device is formed of electrically conducting material, in order to keep the chassis for use in a display-device illumination device out of contact with the first and second holding members, an insulator may be interposed between the first and second holding members and the chassis for use in a display-device illumination device.

In the display-device illumination device of each of the configurations described above, the first holding member and the second holding member each may have at least one portion that has freedom of movement in the direction of the main axes of the tubular lamps but does not have freedom of movement in a direction in which the tubular lamps are arranged side by side and that is fixed to the chassis for use in a display-device illumination device, and the first holding member and the second holding member each may have at least one portion that has freedom of movement in both the direction of the main axes of the tubular lamps and the direction in which the tubular lamps are arranged side by side and that is fixed to the chassis for use in a display-device illumination device. Thus, it is possible to reduce deformation of the first holding member and the second holding member in the direction in which the tubular lamps are arranged side by side.

The display-device illumination device of each of the configurations described above may include a plurality of sets of the first holding member, the second holding member and the tubular lamps held by the holders in the first holding member and the holders in the second holding member. Thus, it is possible to facilitate the use of the display-device illumination device in a larger display screen.

In the display-device illumination device of each of the configurations described above, the first holding member and the second holding member each may have a shock-absorbing portion that reduces deforming stress in the direction in which the tubular lamps are arranged side by side. Thus, it is possible to reduce deformation of the first holding member and the second holding member in the direction in which the tubular lamps are arranged side by side. With the configuration where there is no portion that has freedom of movement in both the direction of the main axes of the tubular lamps and the direction in which the tubular lamps are arranged side by side and that is fixed to the chassis for use in a display-device illumination device, it is possible not only to reduce deformation of the first holding member and the second holding member in the direction in which the tubular lamps are arranged side by side but also to reduce the loose fit of the first holding member and the second holding member in the direction in which the tubular lamps are arranged side by side.

Preferably, at least one shock-absorbing portion is formed between each adjacent pair of fixation portions of the first holding member and between each adjacent pair of fixation portions of the second holding member.

Preferably, in order to avoid stress concentration, the shock-absorbing portion is shaped in cross section such that it includes at least three curved portions and coupling portions coupling the curved portions together.

According to another preferred embodiment of the present invention, a display device (for example, a television set) includes a display-device illumination device configured as described above.

With a display-device illumination device according to a preferred embodiment of the present invention, as tubular lamps thermally expand or contract, the first holding member and the second holding member can move together with the tubular lamps. This helps reduce the possibility of the tubular lamps being broken due to thermal stress.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view schematically showing a cold cathode lamp that can be driven in parallel.

FIG. 2 is a diagram schematically showing the configuration of a display-device illumination device according to a first preferred embodiment of the present invention.

FIG. 3A is a diagram showing a cross-sectional shape of a second holding member included in the display-device illumination device shown in FIG. 2.

FIG. 3B is a diagram showing another cross-sectional shape of the second holding member included in the display-device illumination device shown in FIG. 2.

FIG. 4 is a diagram showing the configuration of components including a chassis in the display-device illumination device according to the first preferred embodiment of the present invention.

FIG. 5A is an enlarged partial view of an area where a first holding member included in the display-device illumination device according to the first preferred embodiment of the invention is fixed.

FIG. 5B is another enlarged partial view of the area where the first holding member included in the display-device illumination device according to the first preferred embodiment of the invention is fixed.

FIG. 6 is a diagram schematically showing the configuration of a display-device illumination device according to a second preferred embodiment of the present invention.

FIG. 7 is a diagram schematically showing the configuration of a display-device illumination device according to a third preferred embodiment of the present invention.

FIG. 8 is a diagram showing a modified example of the display-device illumination device according to the third preferred embodiment of the present invention.

FIG. 9 is a diagram schematically showing the configuration of a display-device illumination device according to a fourth preferred embodiment of the present invention.

FIG. 10 is a diagram showing a modified example of the display-device illumination device according to the fourth preferred embodiment of the present invention.

FIG. 11A is a diagram showing an example of the shape of the second holding member in which a shock-absorbing portion is formed.

FIG. 11B is another diagram showing the example of the shape of the second holding member in which the shock-absorbing portion is formed.

FIG. 11C is another diagram showing the example of the shape of the second holding member in which the shock-absorbing portion is formed.

FIG. 12A is a diagram showing another example of the shape of the second holding member in which the shock-absorbing portion is formed.

FIG. 12B is another diagram showing the example of the shape of the second holding member in which the shock-absorbing portion is formed.

FIG. 12C is another diagram showing the example of the shape of the second holding member in which the shock-absorbing portion is formed.

FIG. 13A is a diagram showing yet another example of the shape of the second holding member in which the shock-absorbing portion is formed.

FIG. 13B is another diagram showing the example of the shape of the second holding member in which the shock-absorbing portion is formed.

FIG. 14A is a diagram showing a modified example of the second holding member shown in FIGS. 11A to 11C.

FIG. 14B is another diagram showing the modified example of the second holding member shown in FIGS. 11A to 11C.

FIG. 14C is another diagram showing the modified example of the second holding member shown in FIGS. 11A to 11C.

FIG. 15A is an enlarged partial view of an area where the first holding member included in the display-device illumination device according to the first preferred embodiment of the invention is fixed, in a case where an example of locking is preferably used.

FIG. 15B is another enlarged partial view of the area where the first holding member included in the display-device illumination device according to the first preferred embodiment of the invention is fixed, in a case where the example of locking is preferably used.

FIG. 16 is an exploded perspective view showing a liquid crystal television set as an example of a display device according to another preferred embodiment of the present invention.

FIG. 17 is a diagram schematically showing the configuration of a conventional display-device illumination device.

FIG. 18A is a diagram showing a cross-sectional shape of a second holding member included in the display-device illumination device shown in FIG. 17.

FIG. 18B is another diagram showing the cross-sectional shape of the second holding member included in the display-device illumination device shown in FIG. 17.

FIG. 19 is a diagram showing the configuration of components including a chassis in the conventional display-device illumination device.

### DETAILED DESCRIPTION OF THE PREFERRED EMBODIMENTS

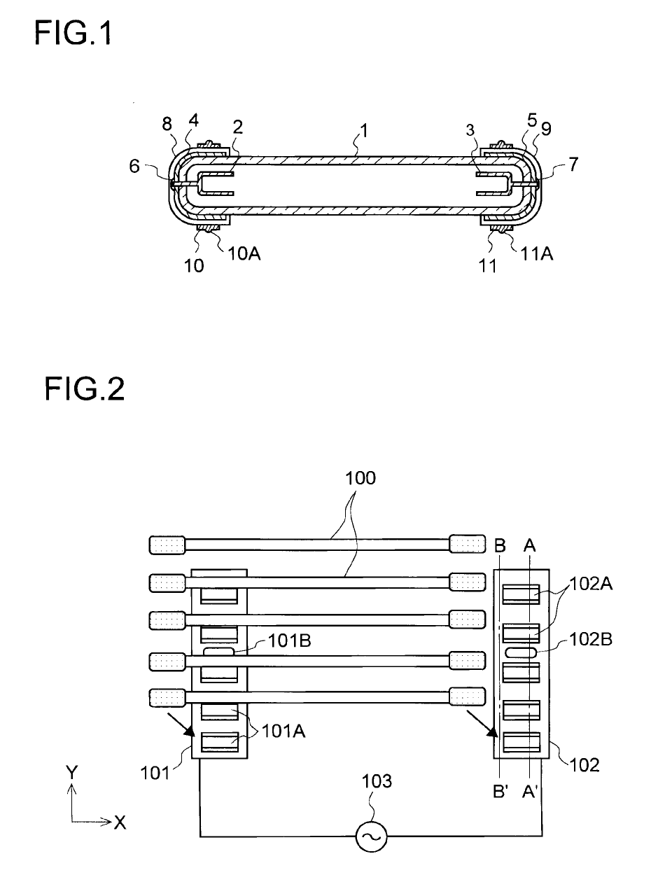

Hereinafter, a description will be given of preferred embodiments of the present invention with reference to the accompanying drawings. In the preferred embodiments described below, cold cathode lamps having a cross-sectional structure shown in FIG. 1 are used as a light source for use in a display device.

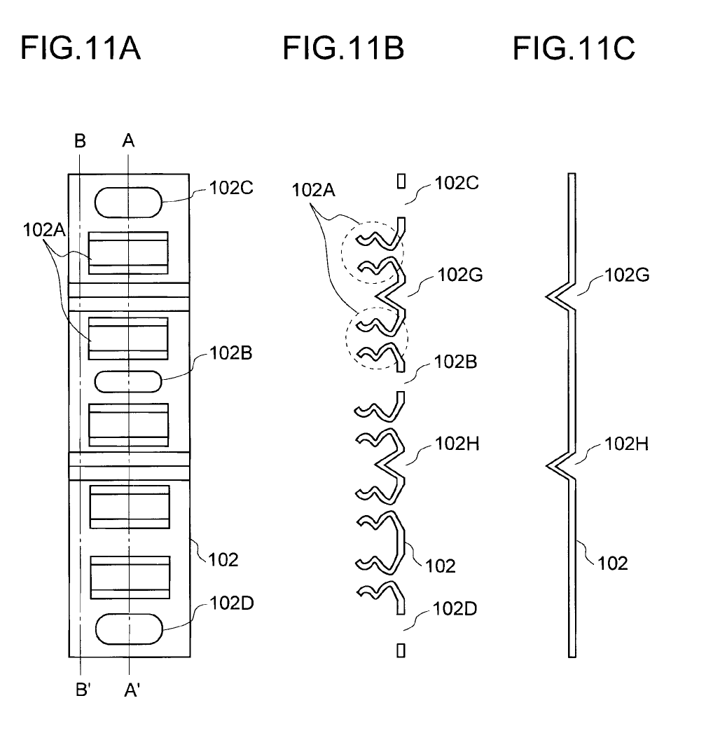

The cold cathode lamp shown in FIG. 1 is one of the cold cathode lamps disclosed in WO2006/051698 A1 (see FIG. 11B in WO2006/051698 A1).

The cold cathode lamp shown in FIG. 1 has internal electrodes 2 and 3 inside a glass tube 1. Parts of the internal electrodes 2 and 3 penetrate the glass tube 1 to protrude outwardly from the glass tube 1, and they serve as electrode terminals. The glass tube 1 configured as described above is sealed. The inner wall of the glass tube 1 is coated with fluorescent material. Generally, neon and argon are sealed in the glass tube 1 preferably in the proportion of about 95 to 5 or about 80 to 20 or in other proportions such that the overall pressure inside the glass tube 1 falls within the range of approximately 5.3×10³ to approximately 10.7×10³ Pa (≈40 to 80 torr), and a few milligrams of mercury is further sealed in the glass tube 1. Instead of mercury, xenon may be sealed in the glass tube 1.

In the cold cathode lamp shown in FIG. 1, external electrodes 4 and 5 are provided at the ends of the glass tube 1, the protrusion of the internal electrode 2 and the external electrode 4 are joined together with solder 6 and the protrusion of the internal electrode 3 and the external electrode 5 are joined together with solder 7. Specific examples of the external electrodes 4 and 5 include a metal paste, a metal foil and a metal cap. The solder 6 and 7 may be omitted as long as satisfactory electrical connections are provided between the protrusion of the internal electrode 2 and the external electrode 4 and between the protrusion of the internal electrode 3 and the external electrode 5.

In the cold cathode lamp shown in FIG. 1, insulating layers 8 and 9 are formed on the external electrodes, and annular band-shaped opposite electrodes 10 and 11 are formed on the insulating layers 8 and 9, respectively. The entire external electrode 4 is covered with the glass tube 1 and the insulating layer 8; the entire external electrode 5 is covered with the glass tube 1 and the insulating layer 9.

In the cold cathode lamp shown in FIG. 1, in order to ensure that the opposite electrodes 10 and 11 and the holders are electrically connected to each other, annular projections 10A and 11A are provided on the annular band-shaped opposite electrodes 10 and 11.

A description will now be given of a first preferred embodiment of the present invention. The configuration of a display-device illumination device according to the first preferred embodiment of the present invention is schematically shown in FIG. 2. In the display-device illumination device according to the first preferred embodiment of the invention, one end of each lamp 100 that is the cold cathode lamp of the configuration shown in FIG. 1 is held by a holder 101A disposed in a first holding member 101, and the other end of each lamp 100 is held by a holder 102A disposed in a second holding member 102. An alternating-current voltage having a frequency of several tens of kilohertz is supplied from a power supply 103 to each lamp 100 through the first holding member 101 and the second holding member 102. The holders 101A and 102A formed by elastic metal members (made of, for example, spring steel) are provided such that they are each equal in number to the lamps. In the approximate centers of the first holding member 101 and the second holding member 102 in the direction in which the lamps are arranged side by side (in the y-axis direction in the figure), elongated holes 101B and 102B longer in the direction of the main axis of the lamp (in the x-axis direction in the figure) are provided. The elongated holes 101B and 102B are symmetrically located. Specifically, a line connecting the elongated holes 101B and 102B is substantially in parallel with the x-axis direction in the figure.

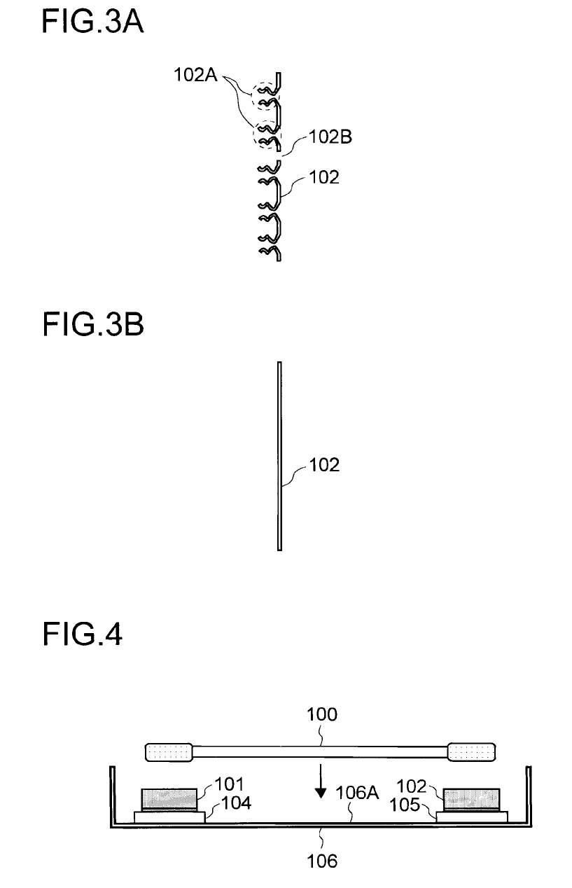

The cross sectional view of the second holding member 102 shown in FIG. 2 taken along line A-A′ is shown in FIG. 3A; the cross sectional view of the second holding member 102 shown in FIG. 2 taken along line B-B′ is shown in FIG. 3B. The first holding member 101 has the same shape as the second holding member 102.

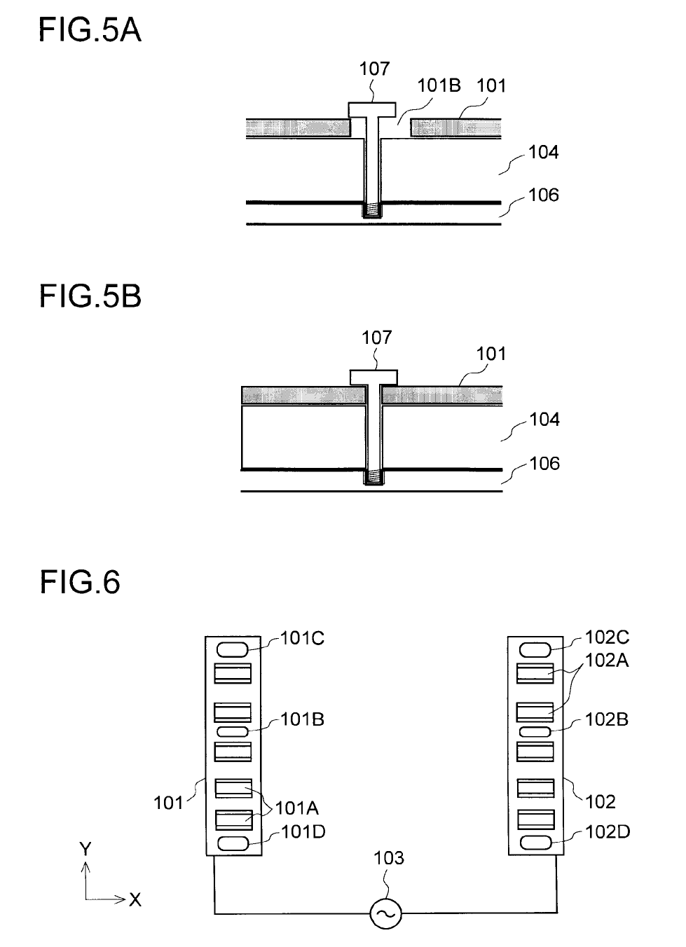

The configuration of components including a chassis in the display-device illumination device according to the first preferred embodiment of the present invention is shown in FIG. 4. The first holding member 101 is not fixed to a first insulating member 104; the first insulating member 104 is fixed, without freedom of movement, to the chassis 106 in the display-device illumination device. The first holding member 101 is loosely fixed, with a screw (unillustrated in FIG. 4) formed of insulating material, to the chassis 106 in the display-device illumination device such that the first holding member 101 has freedom of movement in the direction of the main axis of the lamp (in the x-axis direction in FIG. 2) but does not have freedom of movement in the direction in which the lamps are arranged side by side (in the y-axis direction in FIG. 2). Enlarged partial views of an area where the first holding member 101 is fixed are shown in FIGS. 5A and 5B. FIG. 5A is a cross-sectional view taken along the x-axis in FIG. 2, and the holder 101A is not shown in the figure. FIG. 5B is a cross-sectional view taken along the y-axis in FIG. 2. The screw 107 penetrates the elongated hole 101B in the first holding member 101 and a penetration hole in the first insulating member 104, and is screwed into the chassis 106 in the display-device illumination device.

Likewise, the second holding member 102 is not fixed to a second insulating member 105, and the second insulating member 105 is fixed, without freedom of movement, to the chassis 106 in the display-device illumination device. The second holding member 102 is loosely fixed, with a screw (unillustrated in FIG. 4) formed of insulating material, to the chassis 106 in the display-device illumination device such that the second holding member 102 has freedom of movement in the direction of the main axis of the lamp (in the x-axis direction in FIG. 2) but does not have freedom of movement in the direction in which the lamps are arranged side by side (in the y-axis direction in FIG. 2).

As each lamp 100 thermally expands or contracts, the first holding member 101 and the second holding member 102 attempt to move together with each lamp 100. In the display-device illumination device according to the first preferred embodiment of the present invention, since the first holding member 101 and the second holding member 102 are loosely fixed to the chassis 106 in the display-device illumination device such that they have freedom of movement in the direction of the main axis of the lamp (in the x-axis direction in FIG. 2), the first holding member 101 and the second holding member 102 can move together with each lamp 100 as each lamp 100 thermally expands or contracts. Thus, it is possible to significantly reduce thermal stress exerted on each lamp 100 in the direction of the main axis of the lamp. This helps reduce the possibility of each lamp 100 being broken due to thermal stress.

Since an optically reflective sheet of insulating resin is commonly placed over the inside back 106A (see FIG. 4) of the chassis in the display-device illumination device, the optically reflective sheet may include the functions of the first insulating member 104 and the second insulating member 105 without the provision of the first insulating member 104 and the second insulating member 105. An insulating coating may be applied to the inside back 106A (see FIG. 4) of the chassis in the display-device illumination device, and the insulating coating may be used instead of the first insulating member 104 and the second insulating member 105 without the provision of the first insulating member 104 and the second insulating member 105.

In a case where the chassis 106 in the display-device illumination device is formed of aluminum or stainless steel, it is necessary to keep the chassis 106 in the display-device illumination device out of contact with the first holding member 101 and the second holding member 102. In a case where the chassis 106 in the display-device illumination device is formed of insulating member such as resin, the chassis 106 in the display-device illumination device may be in contact with the first holding member 101 and the second holding member 102. Thus, the first insulating member 104 and the second insulating member 105 may be removed, and the first holding member 101 and the second holding member 102 may be directly fixed to the chassis 106 in the display-device illumination device with a screw formed of insulating material such that they have freedom of movement in the direction of the main axis of the lamp (in the x-axis direction in FIG. 2) and do not have freedom of movement in the direction in which the lamps are arranged side by side (in the y-axis direction in FIG. 2).

A description will now be given of a second preferred embodiment of the present invention. The configuration of a display-device illumination device according to the second preferred embodiment of the invention is schematically shown in FIG. 6. In FIG. 6, such elements as are found also in FIG. 2 are identified with common reference numerals and their detailed description will not be repeated. In FIG. 6, each lamp 100 shown in FIG. 2 is omitted.

Like the display-device illumination device according to the first preferred embodiment of the present invention, the display-device illumination device according to the second preferred embodiment of the present invention has the first insulating member 104, the second insulating member 105, the chassis 106 in the display-device illumination device and the screws 107 (see FIGS. 4, 5A and 5B)

The display-device illumination device according to the second preferred embodiment of the present invention differs from the display-device illumination device according to the first preferred embodiment of the invention in that: the first holding member 101 has not only the elongated hole 101B but also elongated holes 101C and 101D; the second holding member 102 has not only the elongated hole 102B but also elongated holes 102C and 102D; and correspondingly, the positions and the number of penetration holes in the first insulating member 104, the positions and the number of penetration holes in the second insulating member 105, the positions and the number of screw holes in the chassis 106 in the display-device illumination device and the number of screws 107 are different between them.

In the upper end of the first holding member 101 in the direction in which the lamps are arranged side by side (in the y-axis direction in FIG. 6), the elongated hole 101C is provided in which its length in the direction of the main axis of the lamp (in the x-axis direction in FIG. 6) is longer than its width, and the width in the direction in which the lamps are arranged side by side (in the y-axis direction in FIG. 6) is wider than that of the elongated hole 101B. In the lower end of the first holding member 101 in the direction in which the lamps are arranged side by side (in the y-axis direction in FIG. 6), the elongated hole 101D is provided in which its length in the direction of the main axis of the lamp (in the x-axis direction in FIG. 6) is longer than its width, and the width in the direction in which the lamps are arranged side by side (in the y-axis direction in FIG. 6) is wider than that of the elongated hole 101B.

Likewise, in the upper end of the second holding member 102 in the direction in which the lamps are arranged side by side (in the y-axis direction in FIG. 6), the elongated hole 102C is provided in which its length in the direction of the main axis of the lamp (in the x-axis direction in FIG. 6) is longer than its width, and the width in the direction in which the lamps are arranged side by side (in the y-axis direction in FIG. 6) is wider than that of the elongated hole 102B. In the lower end of the second holding member 102 in the direction in which the lamps are arranged side by side (in the y-axis direction in FIG. 6), the elongated hole 102D is provided in which its length in the direction of the main axis of the lamp (in the x-axis direction in FIG. 6) is longer than its width, and the width in the direction in which the lamps are arranged side by side (in the y-axis direction in FIG. 6) is wider than that of the elongated hole 102B.

In a case where the first holding member 101 and the second holding member 102 are fixed to the first and second insulating members 104 and 105 and the chassis 106 in the display-device illumination device such that they do not have freedom of movement in the direction in which the lamps are arranged side by side (in the y-axis direction in FIG. 6), the first holding member 101 and the second holding member 102 deform due to differences in temperature or thermal expansion between the first and second holding members 101 and 102 and the first and second insulating members 104 and 105 and due to differences in temperature or thermal expansion between the first and second holding members 101 and 102 and the chassis 106 in the display-device illumination device. At the worst, when such deformation occurs repeatedly, the first holding member 101 and the second holding member 102 break due to metal fatigue.

In the display-device illumination device according to the second preferred embodiment of the present invention, the center portions of the first holding member 101 and the second holding member 102 are fixed, and the upper and lower ends thereof move within certain limits in the direction in which the lamps are arranged side by side (in the y-axis direction in FIG. 6). Thus, it is possible to reduce deformation of the first holding member 101 and the second holding member 102 as described above.

Since an optically reflective sheet of insulating resin is commonly placed over the inside back 106A (see FIG. 4) of the chassis in the display-device illumination device, the optically reflective sheet may include the functions of the first insulating member 104 and the second insulating member 105 without the provision of the first insulating member 104 and the second insulating member 105. An insulating coating may be applied to the inside back 106A (see FIG. 4) of the chassis in the display-device illumination device, and the insulating coating may be used instead of the first insulating member 104 and the second insulating member 105 without the provision of the first insulating member 104 and the second insulating member 105.

In a case where the chassis 106 in the display-device illumination device is formed of aluminum or stainless steel, it is necessary to keep the chassis 106 in the display-device illumination device out of contact with the first holding member 101 and the second holding member 102. In a case where the chassis 106 in the display-device illumination device is formed of insulating member such as resin, the chassis 106 in the display-device illumination device may be in contact with the first holding member 101 and the second holding member 102. Thus, the following procedure may be adopted: the first insulating member 104 and the second insulating member 105 are removed; the first holding member 101 is fixed at the elongated hole 101B to the chassis 106 in the display-device illumination device with a screw formed of insulating material such that it has freedom of movement in the direction of the main axis of the lamp (in the x-axis direction in FIG. 6) but does not have freedom of movement in the direction in which the lamps are arranged side by side (in the y-axis direction in FIG. 6); the first holding member 101 is fixed at the elongated holes 101C and 101D to the chassis 106 in the display-device illumination device with screws formed of insulating material such that it has freedom of movement in both the direction of the main axis of the lamp (in the x-axis direction in FIG. 6) and the direction in which the lamps are arranged side by side (in the y-axis direction in FIG. 6); the second holding member 102 is fixed at the elongated hole 102B to the chassis 106 in the display-device illumination device with a screw formed of insulating material such that it has freedom of movement in the direction of the main axis of the lamp (in the x-axis direction in FIG. 6) but does not have freedom of movement in the direction in which the lamps are arranged side by side (in the y-axis direction in FIG. 6); and the second holding member 102 is fixed at the elongated holes 102C and 102D to the chassis 106 in the display-device illumination device with screws formed of insulating material such that it has freedom of movement in both the direction of the main axis of the lamp (in the x-axis direction in FIG. 6) and the direction in which the lamps are arranged side by side (in the y-axis direction in FIG. 6).

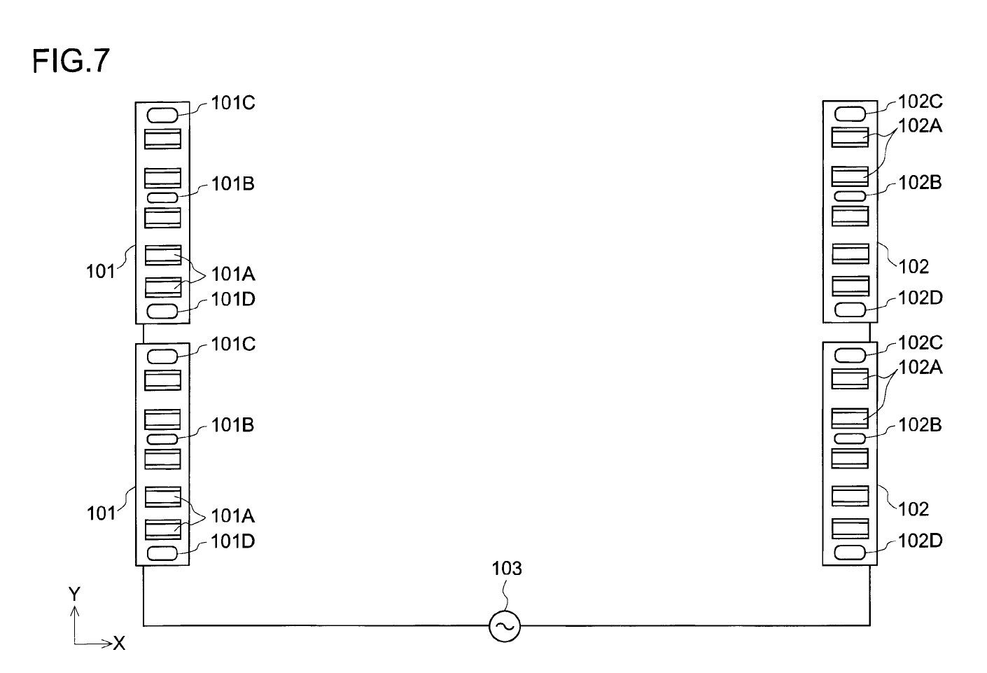

A description will now be given of a third preferred embodiment of the present invention. The configuration of a display-device illumination device according to the third preferred embodiment of the present invention is schematically shown in FIG. 7. In FIG. 7, such elements as are found also in FIG. 6 are identified with common reference numerals and their detailed description will not be repeated. In FIG. 7, the lamps are omitted as in FIG. 6.

Like the display-device illumination devices according to the first and second preferred embodiments of the present invention, the display-device illumination device according to the third preferred embodiment of the present invention has the first insulating member 104, the second insulating member 105, the chassis 106 in the display-device illumination device and the screws 107 (see FIGS. 4, 5A and 5B)

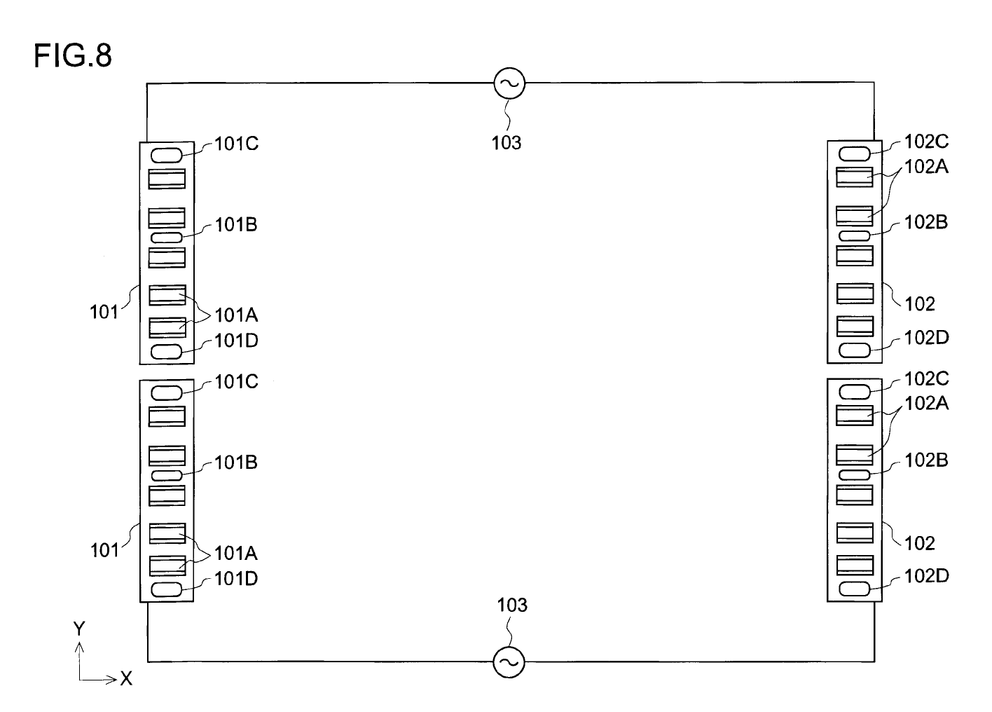

The display-device illumination device according to the third preferred embodiment of the present invention has two sets of each lamp, the first holding member 101, the second holding member 102, the first insulating member 104 and the second insulating member 105 included in the display-device illumination device according to the second preferred embodiment of the present invention; it has one parallel circuit as an electrical circuit. With the two sets of the first holding member 101 and the second holding member 102, it is possible to facilitate the use of the display-device illumination device in a larger display screen. Like a modified example shown in FIG. 8, two sets of the power supply 103 may be arranged so that the electrical circuit includes two parallel circuits.

Since an optically reflective sheet of insulating resin is commonly placed over the inside back 106A (see FIG. 4) of the chassis in the display-device illumination device, the optically reflective sheet may include the functions of the first insulating member 104 and the second insulating member 105 without the provision of the first insulating member 104 and the second insulating member 105. An insulating coating may be applied to the inside back 106A (see FIG. 4) of the chassis in the display-device illumination device, and the insulating coating may be used instead of the first insulating member 104 and the second insulating member 105 without the provision of the first insulating member 104 and the second insulating member 105.

In a case where the chassis 106 in the display-device illumination device is formed of aluminum or stainless steel, it is necessary to keep the chassis 106 in the display-device illumination device out of contact with the first holding members 101 and the second holding members 102. In a case where the chassis 106 in the display-device illumination device is formed of insulating member such as resin, the chassis 106 in the display-device illumination device may be in contact with the first holding members 101 and the second holding members 102. Thus, the following procedure may be adopted: the first insulating member 104 and the second insulating member 105 are removed; the first holding members 101 are fixed at the elongated holes 101B to the chassis 106 in the display-device illumination device with screws formed of insulating material such that they have freedom of movement in the direction of the main axis of the lamp (in the x-axis direction in FIG. 7) but do not have freedom of movement in the direction in which the lamps are arranged side by side (in the y-axis direction in FIG. 7); the first holding members 101 are fixed at the elongated holes 101C and 101D to the chassis 106 in the display-device illumination device with screws formed of insulating material such that they have freedom of movement in both the direction of the main axis of the lamp (in the x-axis direction in FIG. 7) and the direction in which the lamps are arranged side by side (in the y-axis direction in FIG. 7); the second holding members 102 are fixed at the elongated holes 102B to the chassis 106 in the display-device illumination device with screws formed of insulating material such that they have freedom of movement in the direction of the main axis of the lamp (in the x-axis direction in FIG. 7) but do not have freedom of movement in the direction in which the lamps are arranged side by side (in the y-axis direction in FIG. 7); and the second holding members 102 are fixed at the elongated holes 102C and 102D to the chassis 106 in the display-device illumination device with screws formed of insulating material such that they have freedom of movement in both the direction of the main axis of the lamp (in the x-axis direction in FIG. 7) and the direction in which the lamps are arranged side by side (in the y-axis direction in FIG. 7).

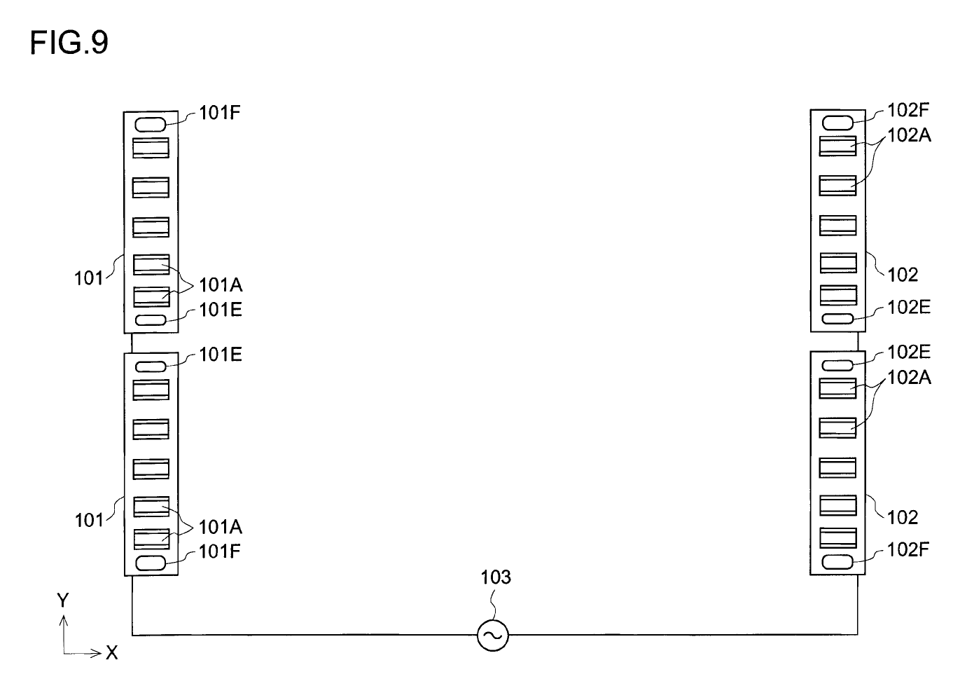

A description will now be given of a fourth preferred embodiment of the present invention. The configuration of a display-device illumination device according to the fourth preferred embodiment of the invention is schematically shown in FIG. 9. In FIG. 9, such elements as are found also in FIG. 7 are identified with common reference numerals and their detailed description will not be repeated. In FIG. 9, the lamps are omitted as in FIG. 7.

Like the display-device illumination devices according to the first to third preferred embodiments of the present invention, the display-device illumination device according to the fourth preferred embodiment of the present invention has the first insulating member 104, the second insulating member 105, the chassis 106 in the display-device illumination device and the screws 107 (see FIGS. 4, 5A and 5B).

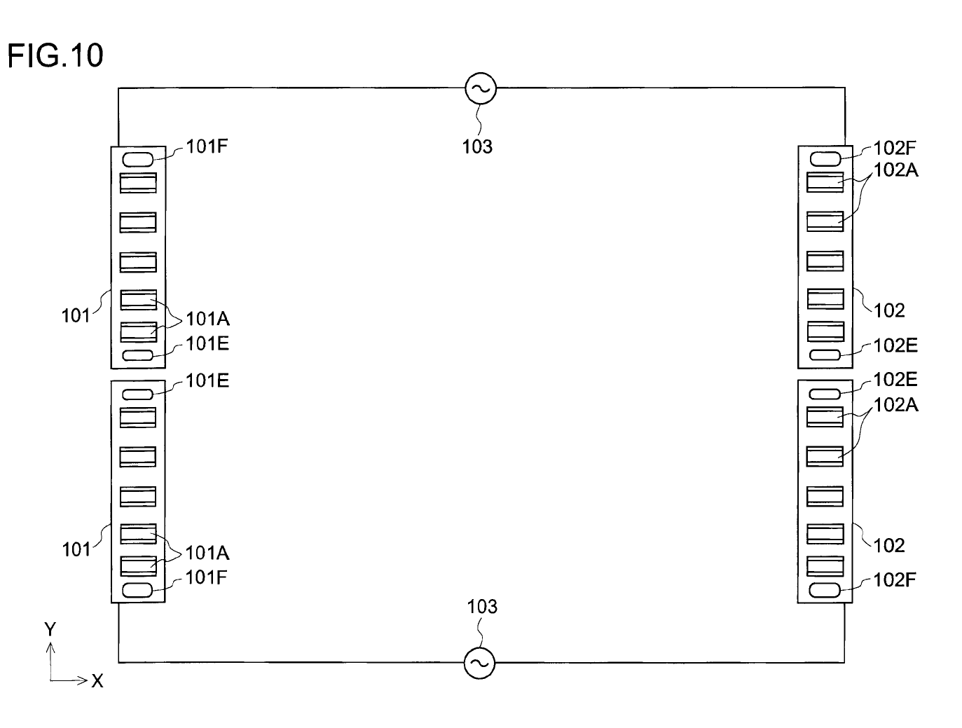

The display-device illumination device according to the fourth preferred embodiment of the present invention differs from the display-device illumination device according to the third preferred embodiment of the present invention in that: the first holding members 101 have, instead of the elongated hole 101B, an elongated hole 101E that has the same shape as the elongated hole 101B, at one end thereof in the direction in which the lamps are arranged side by side (in the y-axis direction in FIG. 9); the first holding members 102 have, instead of the elongated holes 101C and 101D, an elongated hole 101F that has the same shape as the elongated holes 101C and 101D, at the other end thereof in the direction in which the lamps are arranged side by side (in the y-axis direction in FIG. 9); the second holding members 102 have, instead of the elongated hole 102B, an elongated hole 102E that has the same shape as the elongated hole 102B, at one end thereof in the direction in which the lamps are arranged side by side (in the y-axis direction in FIG. 9); the second holding members 102 have, instead of the elongated holes 102C and 102D, an elongated hole 102F that has the same shape as the elongated holes 102C and 102D, at the other end thereof in the direction in which the lamps are arranged side by side (in the y-axis direction in FIG. 9); and correspondingly, the positions and the number of penetration holes in the first insulating member 104, the positions and the number of penetration holes in the second insulating member 105, the positions and the number of screw holes in the chassis 106 in the display-device illumination device and the number of screws 107 are different between them. The display-device illumination device according to the fourth preferred embodiment of the present invention has one parallel circuit as an electrical circuit. With the two sets of the first holding member 101 and the second holding member 102, it is possible to facilitate the use of the display-device illumination device in a larger display screen. Like a modified example shown in FIG. 10, two sets of the power supply 103 may be arranged so that the electrical circuit includes two parallel circuits.

Since an optically reflective sheet of insulating resin is commonly placed over the inside back 106A (see FIG. 4) of the chassis in the display-device illumination device, the optically reflective sheet may include the functions of the first insulating member 104 and the second insulating member 105 without the provision of the first insulating member 104 and the second insulating member 105. An insulating coating may be applied to the inside back 106A (see FIG. 4) of the chassis in the display-device illumination device, and the insulating coating may be used instead of the first insulating member 104 and the second insulating member 105 without the provision of the first insulating member 104 and the second insulating member 105.

In a case where the chassis 106 in the display-device illumination device is formed of aluminum or stainless steel, it is necessary to keep the chassis 106 in the display-device illumination device out of contact with the first holding members 101 and the second holding members 102. In a case where the chassis 106 in the display-device illumination device is formed of an insulating member such as resin, the chassis 106 in the display-device illumination device may be in contact with the first holding members 101 and the second holding members 102. Thus, the following procedure may be adopted: the first insulating member 104 and the second insulating member 105 are removed; the first holding members 101 are fixed at the elongated holes 101E to the chassis 106 in the display-device illumination device with screws formed of insulating material such that they have freedom of movement in the direction of the main axis of the lamp (in the x-axis direction in FIG. 9) but do not have freedom of movement in the direction in which the lamps are arranged side by side (in the y-axis direction in FIG. 9); the first holding members 101 are fixed at the elongated holes 101F to the chassis 106 in the display-device illumination device with screws formed of insulating material such that they have freedom of movement in both the direction of the main axis of the lamp (in the x-axis direction in FIG. 9) and the direction in which the lamps are arranged side by side (in the y-axis direction in FIG. 9); the second holding members 102 are fixed at the elongated holes 102E to the chassis 106 in the display-device illumination device with screws formed of insulating material such that they have freedom of movement in the direction of the main axis of the lamp (in the x-axis direction in FIG. 9) but do not have freedom of movement in the direction in which the lamps are arranged side by side (in the y-axis direction in FIG. 9); and the second holding members 102 are fixed at the elongated holes 102F to the chassis 106 in the display-device illumination device with screws formed of insulating material such that they have freedom of movement in both the direction of the main axis of the lamp (in the x-axis direction in FIG. 9) and the direction in which the lamps are arranged side by side (in the y-axis direction in FIG. 9).

Shock-absorbing portions for reducing thermal stress in the direction in which the lamps are arranged side by side may be formed in the first holding member 101 and the second holding member 102. At least one shock-absorbing portion is provided between each adjacent pair of the fixation portions (for example, in the second preferred embodiment of the present invention, at four positions, one between the elongated holes 101B and 101C, one between the elongated holes 101B and 101D, one between the elongated holes 102B and 102C and one between the elongated holes 102B and 102D) of the first holding member 101 and the second holding member 102.

The shape of the second holding member 102 when the above-mentioned shock-absorbing portions are formed in the second holding member 102 included in the display-device illumination device according to the second preferred embodiment of the present invention is shown in FIGS. 11A to 11C. FIG. 11B is a cross-sectional view taken along line A-A′ of FIG. 11A; FIG. 11C is a cross-sectional view taken along line B-B′ of FIG. 11A. The second holding member 102 has a shock-absorbing portion 102G between the elongated holes 102B and 102C and a shock-absorbing portion 102H between the elongated holes 102B and 102D.

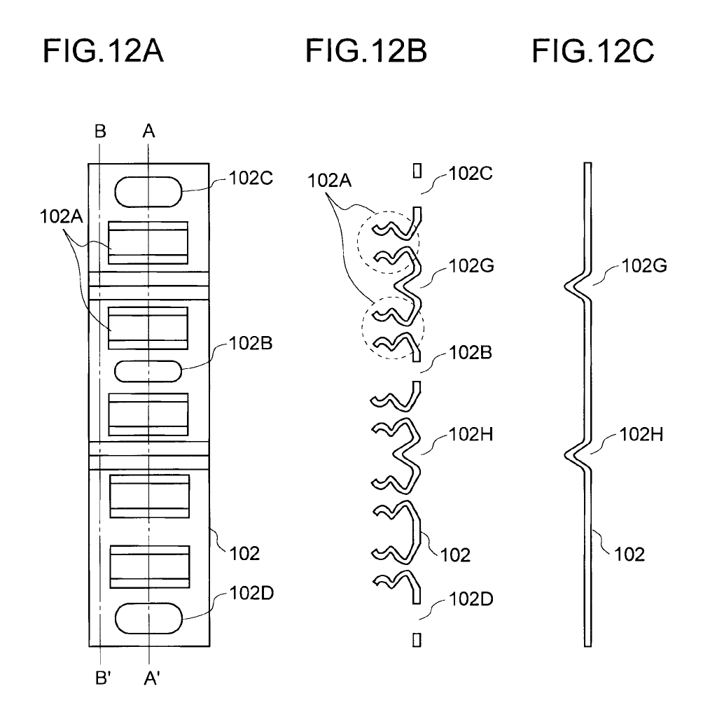

Preferably, the inflection portions of the shock-absorbing portions 102G and 102H shown in FIGS. 11A to 11C are curved such that they are formed in the shape shown in FIGS. 12A to 12C. As shown in FIGS. 12A to 12C, the shock-absorbing portion is shaped in cross section such that it is composed of three curved portions and coupling portions that couples the curved portions together. Thus, it is possible to avoid stress concentration that occurs in the inflection portions shown in FIGS. 11A to 11C.

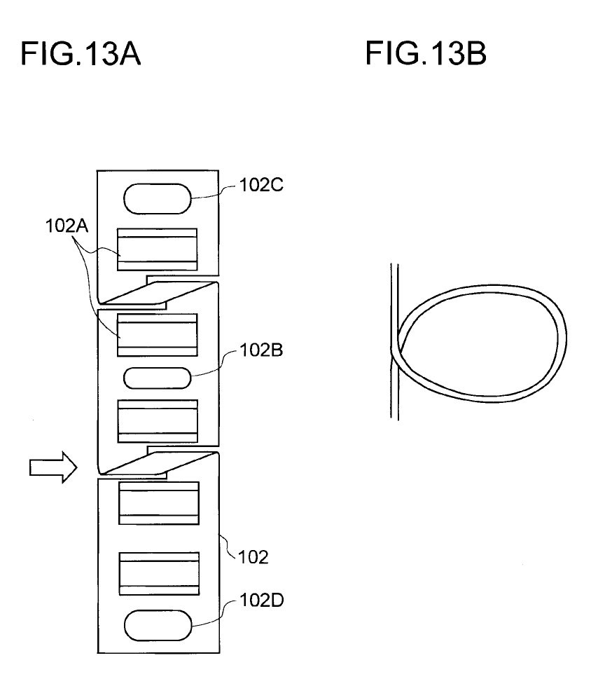

As another shape of the shock-absorbing portion, for example, there is provided a loop shape shown in FIGS. 13A and 13B. FIG. 13B is an enlarged partial view of the loop-shaped shock-absorbing portion as seen from the direction indicated by the arrow shown in FIG. 13A.

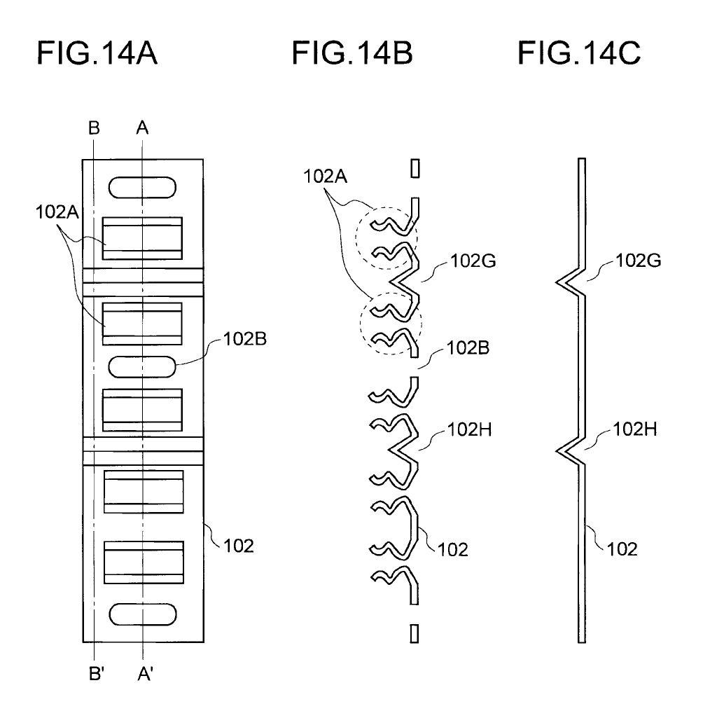

With the above-described shock-absorbing portions formed in the first holding member 101 and the second holding member 102, even if all the elongated holes provided in the first holding member 101 and the second holding member 102 have the same shape as the elongated holes 101B and 102B (for example, see FIGS. 14A to 14C), it is possible to reduce deformation that results from differences in temperature or thermal expansion between the first and second holding members 101 and 102 and the first and second insulating members 104 and 105 and differences in temperature or thermal expansion between the first and second holding members 101 and 102 and the chassis 106 in the display-device illumination device and that occurs in the direction in which the lamps on the first holding member 101 and the second holding member 102 are arranged side by side. All the elongated holes provided in the first holding member 101 and the second holding member 102 may be formed in the same shape as that of the elongated holes 101B and 102B. Thus, it is possible to reduce the loose fit of the first holding member 101 and the second holding member 102 in the direction in which the lamps are arranged side by side. All the elongated holes provided in the first holding member 101 and the second holding member 102 are formed in shapes different from that of the elongated holes 101B and 102B, and thus deformation in the first holding member 101 and the second holding member 102 may be reduced with both the elongated holes and shock-absorbing portions.

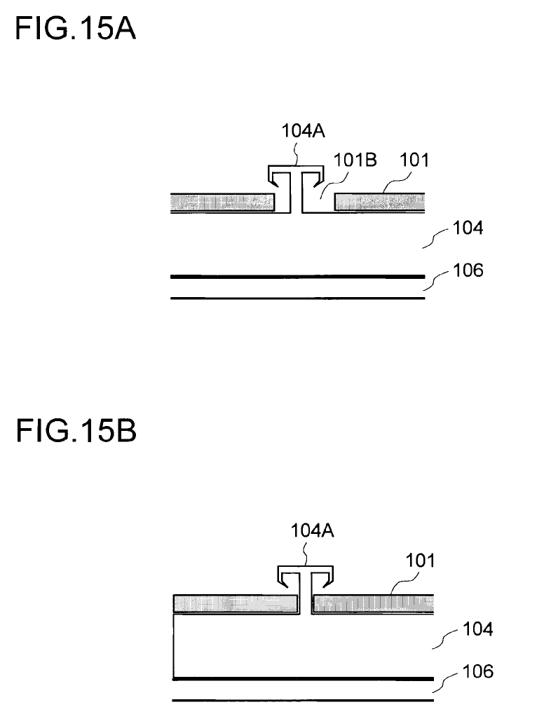

Although in the embodiments described above, the holding members are fixed to the chassis in the display-device illumination device with the elongated holes and screws, the present invention is not limited to this configuration. For example, the holding members may be fixed to the chassis in the display-device illumination device by locking. One example of such a locking method is shown in FIGS. 15A and 15B. FIGS. 15A and 15B are enlarged partial views of an area where the first holding member 101 is fixed. FIG. 15A is a cross-sectional view taken in the x-axis direction in FIG. 2, where the holder 101A is omitted. FIG. 15B is a cross-sectional view taken in the y-axis direction in FIG. 2. The first insulating member 104 has an integrally molded locking portion 104A. The elongated hole 101B in the first holding member 101 is locked by the locking portion 104A.

A display device according to another preferred embodiment of the present invention has a display-device illumination device according to one of the above-described preferred embodiments of the present invention and a display panel. As a specific preferred embodiment of a display device according to the present invention, for example, there is provided a transmissive liquid crystal display device that uses, as a backlight, a display-device illumination device according to a preferred embodiment of the present invention and that has a liquid crystal display panel on the front of the backlight.

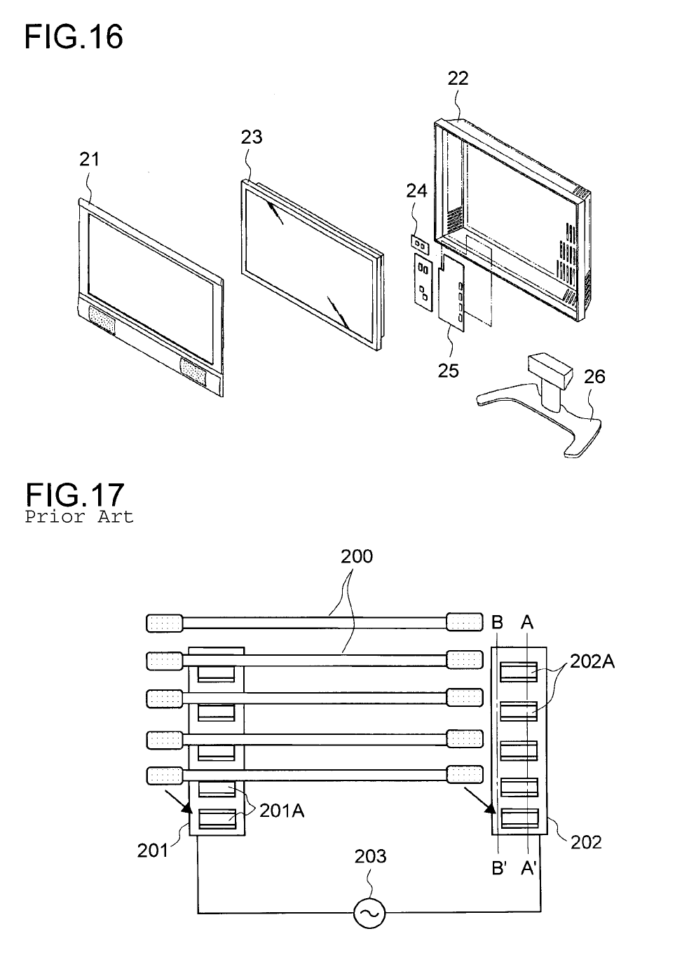

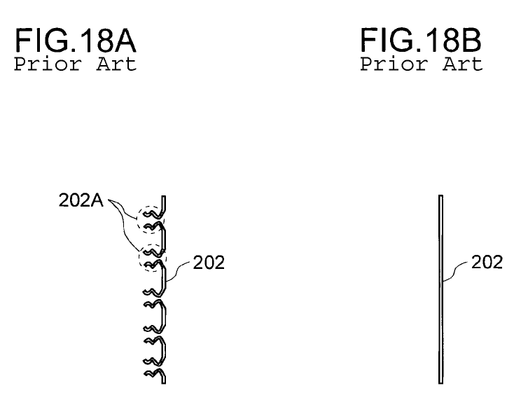

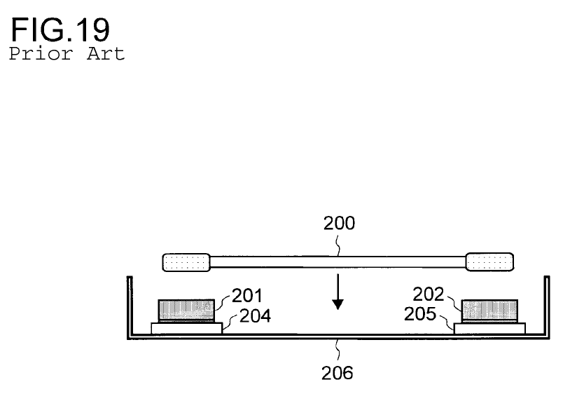

One example of an exploded perspective view of a liquid crystal television set is shown in FIG. 16 in a case where a display device according to a preferred embodiment of the present invention is a liquid crystal television set. A transmissive liquid crystal display section 23, a tuner 24 and a power supply 25 are housed between a front cabinet 21 and a rear cabinet 22; the rear cabinet 22 is supported on a stand 26. The transmissive liquid crystal display section 23 uses, as a backlight, a display-device illumination device according to a preferred embodiment of the present invention and has a liquid crystal display panel on the front of the backlight.

Although in the preferred embodiments of the present invention, the cold cathode lamp shown in FIG. 1 is preferably used, a lamp for use in a display-device illumination device according to the present invention is not limited to this cold cathode lamp. Any other lamp that can be driven in parallel may be used; any other cold cathode lamp such as those disclosed in WO2006/051698 A1 or any external electrode fluorescent lamp may be used. For example, the lamp obtained by removing the insulating layers 8 and 9 and the opposite electrodes 10 and 11 from the cold cathode lamp shown in FIG. 1 may be used. In this case, it is necessary to apply, without fail, an insulating coating to the surfaces of the holders 101A in the first holding member 101 and the holders 102A in the second holding member 102 where the holders 101A and 102A make contact with lamps.

Display-device illumination devices according to various preferred embodiments of the present invention can be applied to backlights for use in liquid crystal television sets and various devices for use in display devices.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-9. (canceled)

10: A display-device illumination device comprising:
a plurality of tubular lamps that can be driven in parallel;
a first holding member having a same number of holders as a number of the tubular lamps, the holders of the first holding member being arranged to hold first ends of the tubular lamps;
a second holding member having a same number of holders as a number of the tubular lamps, the holders of the second holding member being arranged to hold the other ends of the tubular lamps;
a power supply arranged to supply electric power to the tubular lamps through the first holding member and the second holding member; and
a chassis; wherein
the first holding member and the second holding member are fixed to the chassis so as to have freedom of movement in a direction of main axes of the tubular lamps.

11: The display-device illumination device of claim 10, wherein the chassis is formed of electrically conducting material, and an insulator is interposed between the first and second holding members and the chassis.

12: The display-device illumination device of claim 10, wherein the first holding member and the second holding member each have at least one portion that has freedom of movement in the direction of the main axes of the tubular lamps but does not have freedom of movement in a direction in which the tubular lamps are arranged side by side and that is fixed to the chassis, and the first holding member and the second holding member each have at least one portion that has freedom of movement in both the direction of the main axes of the tubular lamps and the direction in which the tubular lamps are arranged side by side and that is fixed to the chassis.

13: The display-device illumination device of claim 10, wherein the display-device illumination device comprises a plurality of sets of the first holding member, the second holding member and the tubular lamps held by the holders in the first holding member and the holders in the second holding member.

14: The display-device illumination device of claim 10, wherein the first holding member and the second holding member each have a shock-absorbing portion that reduces deforming stress in the direction in which the tubular lamps are arranged side by side.

15: The display-device illumination device of claim 14, wherein at least one said shock-absorbing portion is formed between each adjacent pair of fixation portions of the first holding member and between each adjacent pair of fixation portions of the second holding member.

16: The display-device illumination device of claim 14, wherein the shock-absorbing portion is shaped in cross section such that the shock-absorbing portion includes at least three curved portions and coupling portions coupling the curved portions together.

17: A display device comprising:
the display-device illumination device of claim 10.

18: The display device of claim 17, wherein the display device is a television set.

19: A display device comprising:
the display-device illumination device of claim 11.

20: The display device of claim 19, wherein the display device is a television set.

21: A display device comprising:
the display-device illumination device of claim 12.

22: The display device of claim 21, wherein the display device is a television set.

23: A display device comprising:
the display-device illumination device of claim 13.

24: The display device of claim 23, wherein the display device is a television set.

25: A display device comprising:
the display-device illumination device of claim 14.

26: The display device of claim 25, wherein the display device is a television set.

27: A display device comprising:
the display-device illumination device of claim 15.

28: The display device of claim 27, wherein the display device is a television set.

29: A display device comprising:
the display-device illumination device of claim 16.

30: The display device of claim 29, wherein the display device is a television set.
